(19) United States
(12) Patent Application Publication
(10) Pub. No.: US 2010/0193361 A1
(43) Pub. Date: Aug. 5, 2010

(54) APPARATUS FOR CONCENTRATING DIELECTRIC MICROPARTICLES

(76) Inventors: Takaharu Enjoji, Tokyo (JP); Satoshi Uchida, Tokyo (JP)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/602,555

(22) PCT Filed: May 30, 2008
(86) PCT No.: PCT/JP2008/060001

§ 371 Date: Apr. 5, 2010

(30) Foreign Application Priority Data
Jun. 1, 2007 (JP) 2007-147503

(51) Int. Cl. B01D 57/02

(52) U.S. Cl. 204/643

(57) ABSTRACT

Microorganisms (dielectric microparticles) in a liquid sample are captured using a dielectrophoretic force. After quantifying and analyzing, the microorganisms thus captured are concentrated and collected. In an apparatus for concentrating dielectric microparticles, a liquid sample, which contains the microorganisms to be examined, is supplied from a liquid sample-holding unit holding the liquid sample and passes through a voltage-applied cell. During the passage, the microorganisms are captured on dielectrophoretic electrodes by a dielectrophoretic force. Then, the captured microorganisms are released from the dielectrophoretic force by ceasing the voltage application. At the same time, a release liquid supplied from a release liquid-holding unit is flown through the dielectrophoretic electrodes so that the concentrated microorganisms are released and collected into a collection unit as the target bacteria.

### TECHNICAL FIELD

The present invention relates to an apparatus for concentrating dielectric micro particles which can capture the dielectric micro particles in a liquid sample on the basis of dielectrophoretic force, for easily and quantitatively measuring, analyzing and collecting the captured dielectric micro particles, and for easily washing an inner side of the apparatus after the collection.

### BACKGROUND ART

In recent years, there has been a problem of a food poisoning damage caused by a microorganism such as a salmonella, a staphylococcus, a botulinum, or an O-157 strain of the E. coli bacteria. Concerning firms can carry out an enlightening action and the like in a workshop, which are concerned with a precaution and a sanitation with respect to the microorganism, and intend to prevent an accidental diffusion through an expensive capital investment.

Generally, the kind of microorganism is identified or the quantity of microorganism determined after culturing. In other words, since a culturing operation such as a pre-culture, an enrichment culture or an isolation culture is involved, a term of several days is demanded due to the culturing operation until a result of inspection is issued, and an expert measurement technician is demanded. This long-term measurement comes into question in the case of a necessity of the microorganism inspection to the food stuff, such as a fresh food or the like in which a rapidity is demanded, is generated.

Accordingly, there has been proposed various reagents and apparatuses for easily and rapidly detecting the microorganism. For example, there is an apparatus having electrodes for capturing the microorganism on the basis of dielectrophoretic force, and quantitatively calculating the number of the microorganisms by measuring an impedance between the electrodes Japanese Unexamined Patent Publication 2003-24350. Further, there is an apparatus which can wash an inner side of a measurement chamber by automatically draining a liquid sample after quantitatively analyzing the microorganism captured on the basis of the dielectrophoretic force in the same manner as the Japanese Unexamined Patent Publication 2003-224.

### DISCLOSURE OF THE INVENTION

### Problem to be Solved by the Invention

Both of the patent documents mentioned above aim to quantitatively analyze the captured microorganism, but is not structured such as to intend to collect the captured microorganism. In other words, the microorganism after the quantitative analysis is only discharged and washed, and any method of making good use of the microorganism is not suggested.

In this connection, in recent years, it is demanded to efficiently concentrate a target fungus including a protein such as the microorganism or the like so as to analyze a concentrated liquid, and how the target fungus is efficiently concentrated comes to a question. Provision of such a concentrating technique is expected to play an active part in various fields, for example, in a drink and food field such as a drinking water, a meat, a daily dish, a processed food and the like, in a pharmaceutical and cosmetic field such as a pharmaceutical, a preparation, a chemical, a cosmetic and the like, in a clinical and medical field such as AIDS, a tubercle bacillus, an avian influenza and the like, in a biological industry field such as DNA and RNA, a protein, a nucleic acid and the like, an environment measuring field such as a hot spring, a water treatment, a sewage treatment and the like, and in a marine measuring field such as a ship ballast, a gulf management, a marine pollution and the like.

An aspect of the present invention is made by taking the points mentioned above into consideration, and an object of the present invention is to provide an apparatus for concentrating dielectric micro particles which can capture the dielectric micro particles (for example, microorganisms) in a liquid sample on the basis of dielectrophoretic force, and can concentrate and collect the dielectric micro particles after quantitatively measuring and analyzing the captured dielectric micro particles.

### Means for Solving the Problem

In order to achieve an object mentioned above, an aspect of the apparatus in accordance with the present invention is characterized in that a liquid sample including dielectric micro particles is captured to dielectrophoretic electrodes, a release liquid is flowed through the dielectrophoretic electrodes, and the dielectric micro particles captured by the dielectrophoretic electrodes are concentrated and collected.

More specifically, an aspect of the present invention provides the following matters.

(1) An apparatus for concentrating dielectric micro particles comprising:

a liquid sample holding unit holding a liquid sample including the dielectric micro particles coming to a subject to be inspected;

a cell provided with dielectrophoretic electrodes capturing dielectric micro particles on the basis of dielectrophoretic force;

a release liquid holding unit holding a release liquid flowing through the dielectrophoretic electrodes; and

a collection unit flowing the release liquid supplied from the release liquid holding unit through the dielectrophoretic electrodes and collecting the dielectric micro particles captured by the dielectrophoretic electrodes.

In accordance with an aspect of the present invention having the structure mentioned above, the dielectric micro particles are captured on the dielectrophoretic electrodes on the basis of the dielectrophoretic force, at a time of passing through the cell to which the dielectric micro particles supplied from the liquid sample holding unit are applied. The captured dielectric micro particles are released from the dielectrophoretic force by stopping the application, and are discharged by the release liquid supplied from the release liquid holding unit by being flowed through the dielectrophoretic electrodes, thereby being collected in the collection unit. Accordingly, it is easily possible to collect the concentrated dielectric micro particles as a target fungus.

Further, the dielectric micro particles captured onto the dielectrophoretic electrodes can be observed in real time by a CCD camera, an optical microscope or the like, and a metabolism activity state of the dielectric micro particles can be observed in real time. Further, it is possible to quantitatively measure the dielectric micro particles, by utilizing such a phenomenon that the captured dielectric micro particles form a pearl chain between the electrodes, whereby an extremely low current flows between the electrodes, and measuring (DEPIM) an impedance change between the dielectrophoretic electrodes.

(2) An apparatus for concentrating dielectric micro particles, wherein the apparatus further comprises a stain liquid holding portion holding a stain liquid for applying a labeling material with respect to the dielectric micro particles captured by the dielectrophoretic electrodes.

In accordance with an aspect of the present invention having the structure mentioned above, since it is possible to apply the labeling material with respect to the dielectric micro particles captured by the dielectrophoretic electrodes, at a time when the stain liquid supplied from the stain liquid holding portion passes through the cell, it is possible to quantitatively measure the stained dielectric micro particles in real time on the basis of a fluorescent observation by a fluorescence spectrophotometer and an observation by a fluorescence microscope, by connecting a device for measuring a fluorescence intensity. Specifically, the dielectric micro particles including the labeling material generate fluorescence on the basis of an ultraviolet excitation light generated from a light source, and an electric signal is picked up by receiving it by a detector provided with a light collecting lens. It is possible to optically detect the dielectric micro particles by measuring and analyzing the electric signal.

(3) An apparatus for concentrating dielectric micro particles, wherein air bubbles are mixed into the release liquid, at a time of flowing the release liquid supplied from the release liquid holding unit through the dielectrophoretic electrodes.

In accordance with an aspect of the present invention having the structure mentioned above, it is possible to easily release the dielectric micro particles captured by the dielectrophoretic electrodes by flowing the release liquid into which the air bubbles are mixed through the dielectrophoretic electrodes, and it is possible to easily collect the dielectric micro particles into the collection unit.

(4) An apparatus for concentrating dielectric micro particles, wherein the dielectrophoretic electrodes are covered by a coating film for preventing adsorption of protein.

In accordance with an aspect of the present invention having the structure mentioned above, since it is possible to prevent the dielectric micro particles from being adsorbed to the dielectrophoretic electrodes, it is possible to easily release the dielectric micro particles captured by the dielectrophoretic electrodes, and it is possible to easily collect the dielectric micro particles into the collection unit.

(5) An apparatus for concentrating dielectric micro particles, wherein an electrolyte material affecting an electric conductivity has been previously separated from the liquid sample.

In accordance with an aspect of the present invention having the structure mentioned above, since it is possible to apply the liquid sample having a high concentration of the dielectric micro particles corresponding to the subject to be inspected to the apparatus for concentrating the dielectric micro particles after removing the electrolyte material affecting the electric conductivity, it is possible to more easily collect the concentrated dielectric micro particles as the target fungus.

In other words, there has been known that if a liquid sample obtained by suspending the dielectric micro particles in a medium having a certain level or higher electric conductivity is used in the case of capturing the dielectric micro particles by the dielectrophoretic electrodes, positive DEP (attraction force working toward the electrodes) is hard to act. Accordingly, in the case of separating and collecting the dielectric micro particles from sea water or a food sample, it is necessary to construct a mechanism which can effectively concentrate the fungus with respect to the medium having the high electric conductivity. With regard to these treatments, a centrifugal separation method and a filtration method are effective generally, however, the former has trouble with a damage of a subject (a cell, a microorganism) generated during the treatment and a reduction of a rate of collection, and the latter has trouble with a matter that it takes a lot of time to collect the subject due to a clogging of a used filtration membrane, although being general.

Accordingly, one effective means is a membrane filtration method which is referred to as a cross flow method. It is a method of pressurizing and filtrating a raw material while flowing the raw material horizontally with respect to a separation membrane, in contrast to a general filtration method of pressurizing and separating the raw material vertically to the separation membrane. It is suitable for collecting a residue on the membrane after the filtration, and the case of filtrating a raw material in which a solid material is included and the separation membrane tends to be clogged. It is possible to separate the electrolyte material affecting the electric conductivity from the medium with a high efficiency, by utilizing this principle.

It is possible to collect dielectric micro particles from a medium sample having a high electric conductivity, by using this method together as a pre-treatment mechanism of the apparatus for concentrating the dielectric micro particles.

### Effect of the Invention

In accordance with an aspect of the present invention, it is possible to concentrate and collect the dielectric micro particles captured by the dielectrophoretic electrodes by capturing the liquid sample including the dielectric micro particles to the dielectrophoretic electrodes, and flowing the release liquid through the dielectrophoretic electrodes. Further, the staining step at a time of measuring the dielectric micro particles after the collection is not necessary by applying the stain liquid for applying the labeling material to the dielectric micro particles captured by the dielectrophoretic electrodes before concentrating and collecting the dielectric micro particles so as to stain the dielectric micro particles, and it is possible to provide the stained dielectric micro particles as the target fungus to the measuring apparatus.

### BRIEF DESCRIPTION OF THE DRAWINGS

FIG. 1 is a schematic view of an apparatus for concentrating dielectric micro particles in accordance with an embodiment of the present invention;

FIG. 2 is a schematic view of a cell;

FIG. 3 is a pattern view of dielectrophoretic electrodes within the cell;

FIG. 4 is a schematic view of a flow path system of the apparatus for concentrating the dielectric micro particles in accordance with the embodiment of the present invention;

FIG. 5 is a schematic view of a flow path system for explaining a capturing step of capturing microorganisms by using the apparatus for concentrating the dielectric micro particles in accordance with the embodiment of the present invention;

FIG. 6 is a schematic view of a flow path system for explaining a staining step of staining the microorganisms captured by using the apparatus for concentrating the dielectric micro particles in accordance with the embodiment of the present invention;

FIG. 7 is a schematic view of a flow path system for explaining a pre-release washing step before releasing the microorganisms captured by using the apparatus for concentrating the dielectric micro particles in accordance with the embodiment of the present invention;

FIG. 8 is a schematic view of a flow path system for explaining a releasing step of releasing the microorganisms captured by using the apparatus for concentrating the dielectric micro particles in accordance with the embodiment of the present invention;

FIG. 9 is a schematic view of a flow path system for explaining a washing step of washing the flow path system of the apparatus for concentrating the dielectric micro particles in accordance with the embodiment of the present invention;

FIG. 10 is a schematic view of the flow path system for explaining the washing step of washing the flow path system of the apparatus for concentrating the dielectric micro particles in accordance with the embodiment of the present invention;

FIG. 11 is a schematic view of a flow path system of a cross flow apparatus corresponding to a pre-treatment mechanism of the apparatus for concentrating the dielectric micro particles in accordance with the embodiment of the present invention; and

FIG. 12 is a view showing a reduction of an electric conductivity of a medium by the cross flow.

### BEST MODE FOR CARRYING OUT THE INVENTION

A description will be given below of a best mode for carrying out the present invention with reference to the accompanying drawings.

### Outline

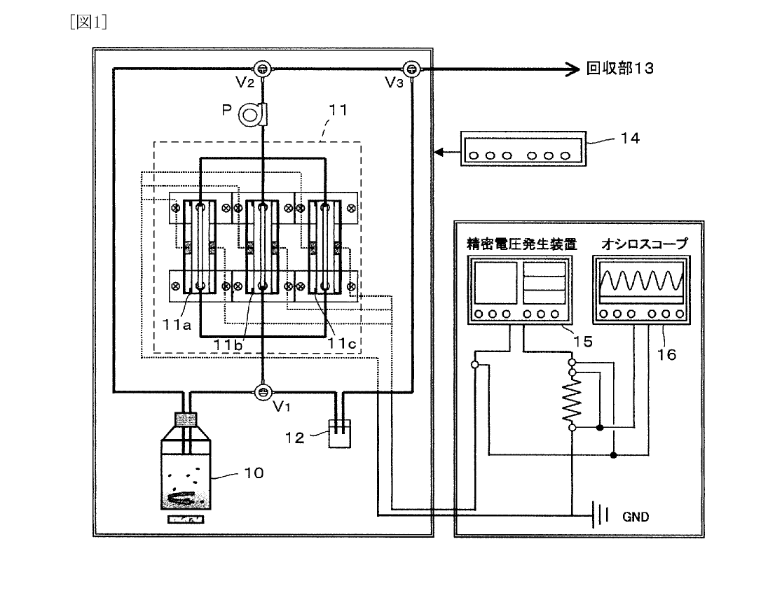

FIG. 1 is a schematic view of an apparatus for concentrating dielectric micro particles 1 in accordance with an embodiment of the present invention.

The apparatus for concentrating dielectric micro particles 1 shown in FIG. 1 is mainly constructed by a liquid sample holding unit 10, a cell 11, a release liquid holding unit 12, and a collection unit 13. In addition, a flow path system is provided with a liquid feed pump P which can control a flow rate to the flow path system, and electromagnetic valves V₁, V₂ and V₃ which can control a direction and a flow rate of the flow path system, and to the apparatus for concentrating dielectric micro particles 1, there are connected a control unit 14 controlling the liquid feed pump P and the electromagnetic valves, a precision voltage generating apparatus 15 applying an electric voltage to dielectrophoretic electrodes of the cell 11, and a voltage measuring apparatus 16.

The liquid sample holding unit 10 is structured such as to hold the liquid sample including the microorganisms corresponding to the dielectric micro particles coming to a subject to be inspected, and makes the liquid sample flow in and out for flowing the liquid sample through the dielectrophoretic electrodes 11a to 11c of the cell 11. In this case, the liquid sample is preferably treated such that a bulky contamination is removed by previously filtrating, and is preferably treated such that a material having a high electric conductivity is removed by applying a deionizing treatment via an ion exchange resin or the like. In this case, as the dielectric micro particles, a nano virus, a fungus, a nano particle and the like are included in addition to the microorganisms.

The release liquid holding unit 12 holds a release liquid for flowing through the dielectrophoretic electrodes and releasing the microorganisms captured by the dielectrophoretic electrodes. The release liquid employs a liquid which can collect the microorganisms captured by the dielectrophoretic electrodes just as they are, such as a phosphate buffer liquid and the like.

The collection unit 13 is to collect the microorganisms captured by the dielectrophoretic electrodes, and can employ various intended uses such as an application of the collected microorganisms to another analyzing apparatus and the like. Since only the microorganisms can be collected from the liquid sample held by the liquid sample holding unit, it is possible to concentrate the microorganisms included in 100 cc of liquid sample into 1 cc liquid solution so as to be collected, for example.

### Cell

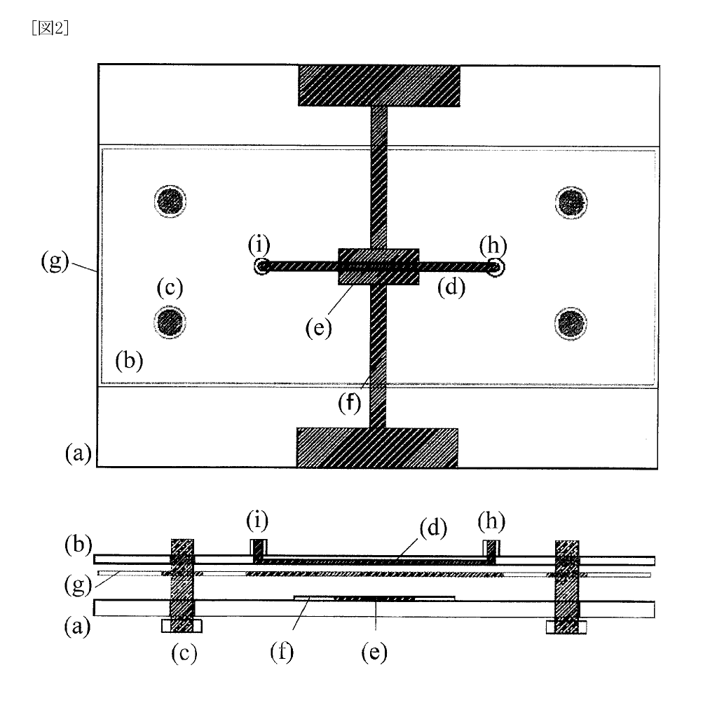

FIG. 2 is a schematic view of the cell 11, and FIG. 3 is a pattern view of the dielectrophoretic electrodes within the cell 11.

The cell 11 is structured such that a base plate (a) is provided with an inflow port (h) and an outflow port (i), and the liquid sample flows in a flow path (d) from a right side on the drawing to a left side. A material of a flow path cover (b) constructing the flow path (d) is a glass, an acrylic, a soft poly-dimethyl siloxane (PDMS) or the like, and is not limited. Further, in the cell 11, a dielectrophoretic electrode portion (f) is provided in the flow path (d).

The dielectrophoretic electrode portion (f) can be structured, as shown in FIG. 3, such that ten electrodes are arranged in parallel at even intervals, and a comb-shaped electrode group (a collecting portion (e)) is constructed by alternately combining ten electrodes having the same shape from opposite faces. For example, a width of one electrode can be set to 100 □m, and an interval between the electrodes can be set to 10 □m. Further, the electrode is coated with an interfacial affinity agent (main component: phosphatide) suppressing a nonspecific reaction of the microorganism, the cell or the like so as to prevent an adsorption thereof as a coating film.

In this case, the dielectrophoretic electrode portion (f) is manufactured by depositing a material to which dielectrophoretic force is applied, such as a chrome, a gold, a titanium or the like on a silica glass board, however, the board is not limited as far as it is an insulating material.

### Flow Path System

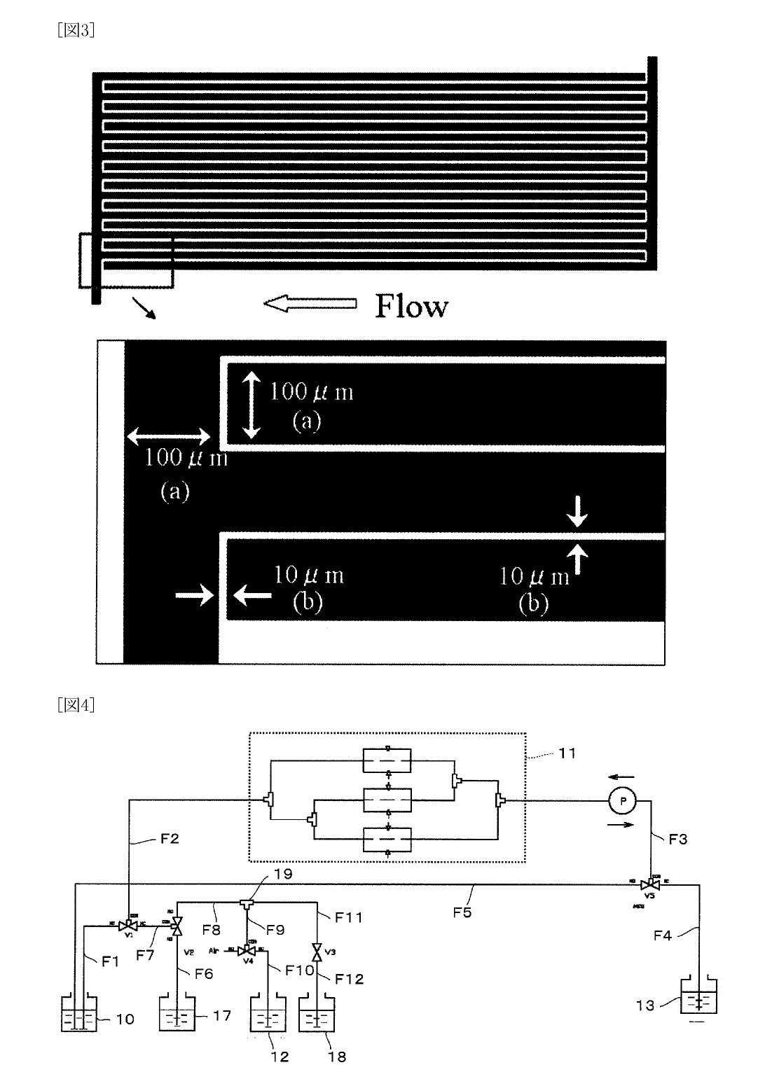

FIG. 4 is a schematic view of a flow path system of the apparatus for concentrating dielectric micro particles 1 in accordance with the embodiment of the present invention.

The apparatus for concentrating dielectric micro particles 1 in accordance with the embodiment of the present invention is mainly constructed by the liquid sample holding unit 10, the cell 11, the release liquid holding unit 12, the collection unit 13, a stain liquid holding portion 17, and a washing liquid holding portion 18. In addition, the flow path system is provided with the liquid feed pump P which can control the flow rate to the flow path system, and the electromagnetic valves V₁, V₂, V₃, V₄ and V₅.

In this case, the electromagnetic valve V₁ serves as an inflow direction control means which can control an inflow direction to the cell 11, and the electromagnetic valve V₅ serves as an outflow direction control means which can control an outflow direction from the cell 11. Further, the electromagnetic valve V₂ serves as a first direction control means connected to the inflow direction control means, and the electromagnetic valves V₃ and V₄ respectively serve as a second direction control means and a third direction control means which are connected to the first direction control means via a T-shaped joint 19. Each of the direction control means can achieve control of a flow rate in addition to the control of the outflow direction.

The stain liquid holding portion 17 is structured such as to hold a stain liquid for applying a labeling material with respect to the microorganisms captured by the dielectrophoretic electrodes. The stain liquid can employ a CFDA acetone solution obtained by diluting 6-carboxyl fluorescein di-acetate by an acetone, or the like.

The washing liquid holding portion 18 is structured such as to hold a washing liquid for washing the flow path system of the apparatus for concentrating dielectric micro particles 1, and is used at a time of washing the flow path system before releasing the microorganisms captured by the dielectrophoretic electrodes, or washing the flow path system of the used apparatus for concentrating dielectric micro particles 1.

One end of the electromagnetic valve V₄ connected to the release liquid holding unit 12 can intermittently mix air bubbles into the release liquid by being intermittently opened. Further, in order to mix the air bubbles, the air bubbles can be intermittently mixed on the basis of an opening and closing motion of the electromagnetic valve V₄ by connecting an apparatus flowing the air bubbles therein which is not illustrated.

The liquid sample holding unit 10 and the cell 11 are connected by flow path F₁-F₂, and the electromagnetic valve V₁ is provided between the flow paths F₁ and F₂. Further, the cell 11 and the liquid sample holding unit 10 are connected by flow path F₃-F₅, and the electromagnetic valve V₅ is provided between the flow paths F₃ and F₅. In this case, the liquid feed pump P is provided in the flow path F₃, and the liquid is flowed in a rightward direction in the drawing on the basis of a forward rotating motion of the pump and in a leftward direction in the drawing on the basis of a reverse rotating motion.

The cell 11 and the collection unit 13 are connected by flow path F₃-F₄, and the electromagnetic valve V₅ is provided between the flow paths F₃ and F₄.

Subsequently, a description will be given of flow path systems of the stain liquid, the release liquid and the washing liquid flowed into the cell 11 through the flow path F₂.

Since any one of the stain liquid, the release liquid and the washing liquid is alternatively flowed into the cell 11, a flow path F₇ is set to a main path, and the electromagnetic valve V₁ is provided between the flow paths F₇ and F₂.

The stain liquid is supplied from a flow path F₆ connected to the stain liquid holding portion 17, and can flow into the cell 11 by the flow path F₆-F₇ being opened by means of the electromagnetic valve V₂.

The release liquid is supplied from a flow path F₁₀ connected to the release liquid holding unit 12, and can flow into the cell 11 by the flow path F₁₀-F₉ being opened by means of the electromagnetic valve V₄, and the flow path F₈-F₇ being opened by means of the electromagnetic valve V₂. In this case, the T-shaped joint 19 is provided between the flow paths F₈ and F₉, however, the flow path F₈-F₉ is always opened.

The washing liquid is supplied from a flow path F₁₂ connected to the washing liquid holding portion 18, and can flow into the cell 11 by the flow path F₁₂-F₁₁ being opened by means of the electromagnetic valve V₃, and the flow path F₈-F₇ being opened by means of the electromagnetic valve V₂. In this case, the T-shaped joint 19 is provided between the flow paths F₈ and F₁₁, however, the flow paths F₈-F₁₁ are always opened.

Among the electromagnetic valves used for securing the above flow path systems, the electromagnetic valves V₁, V₂, V₄ and V₅ can employ a three-way electromagnetic valve for securing a connection from three directions, however, the kind thereof is not limited as far as the connection from three directions can be secured, for example, there is included a four-way electromagnetic valve substantially having the same function as the three-way electromagnetic valve by shutting off one direction. Further, the electromagnetic valve V₃ employs a two-way electromagnetic valve, however, the kind thereof is not limited as far as the connection from two directions can be secured, for example, there is included a three-way electromagnetic valve substantially the same function as the two-way electromagnetic valve by shutting off one direction.

Further, the electromagnetic valve V₁ is structured such that the flow path F₂ is connected to a common port in such a manner as to form the flow path F₁-F₂ and the flow path F₇-F₂. The electromagnetic valve V₂ is structured such that the flow path F₇ is connected to a common port in such a manner as to form the flow path F₆-F₇ and the flow path F₈-F₇. The electromagnetic valve V₃ is connected in such a manner as to form the flow path F₁₁-F₁₂. The electromagnetic valve V₄ is structured such that the flow path F₉ is connected to a common port in such a manner as to form the flow path F₁₀-F₉ and intermittently mix the air bubbles into the flow path F₉. The electromagnetic valve V₅ is structured such that the flow path F₃ is connected to a common port in such a manner as to form the flow path F₃-F₅ and the flow path F₃-F₄.

In this case, the electromagnetic valve V₁ is structured such that the cell 11 is connected to the outflow side, and the liquid sample holding unit 10, and the stain liquid holding portion 17, the release liquid holding unit 12 and the washing liquid holding portion 18 via the electromagnetic valves V₂ to V₄ are connected to the inflow side, and controls whether to flow the liquid sample from the liquid sample holding unit 10 to the cell 11 connected as the common port, or to flow any of the stain liquid from the stain liquid holding portion 17, the release liquid from the release liquid holding unit 12, and the washing liquid from the washing liquid holding portion 18. Further, the electromagnetic valve V₅ is structured such that the cell 11 is connected to the outflow side, and the liquid sample holding unit 10 or the waste liquid holding portion 20 and the collection unit 13 are connected to the inflow side, and controls whether to flow the liquid sample flowed from the cell 11 connected as the common port or the waste liquid to the liquid sample holding unit 10 or the waste liquid holding portion 20, or to flow the captured microorganisms as the concentrated liquid to the collection unit 13.

### Capturing Step

FIG. 5 is a schematic view of a flow path system for explaining a capturing step of capturing the microorganisms by using the apparatus for concentrating dielectric micro particles 1 in accordance with the embodiment of the present invention.

In the capturing step of capturing the microorganisms, the liquid sample supplied from the liquid sample holding unit 10 is flowed through the dielectrophoretic electrodes within the cell 11, and the liquid sample flowing out of the cell 11 is returned to the liquid sample holding unit 10. The liquid sample is circulated within the cell 11 by repeating this again and again, and it is possible to securely capture the microorganisms included in the liquid sample. At this time, it is possible to capture the microorganisms corresponding to the dielectric material in an electrode gap portion between the electrodes, by applying a sine-wave voltage to the dielectrophoretic electrodes.

In the flow path system, the flow path F₁-F₂-F₃-F₅ is formed by opening the flow path F₁-F₂ by the electromagnetic valve V₁, and opening the flow path F₃-F₅ by the electromagnetic valve V₅, in order to secure the flow path F₁ flowing the liquid sample out of the liquid sample holding unit 10, and the flow path F₅ flowing (returning) the liquid sample into the liquid sample holding unit 10. In other words, in the capturing step of capturing the microorganisms, since the present invention mainly aims at concentrating the microorganisms, the flow paths are formed in such a manner as to secure the flow path system between the liquid sample holding unit 10 and the cell 11, disconnect the flow path system with the collection unit 13 in such a manner as to prevent the liquid sample itself from being collected to the collection unit 13, and disconnect the flow path system with the release liquid holding unit 12, the stain liquid holding portion 17 and the washing liquid holding portion 18. Further, it is possible to securely capture the microorganisms included in the liquid sample by forming a close loop flow path circulating through the liquid sample holding unit 10 and the cell 11, and circulating the liquid sample within the cell 11.

### Staining Step

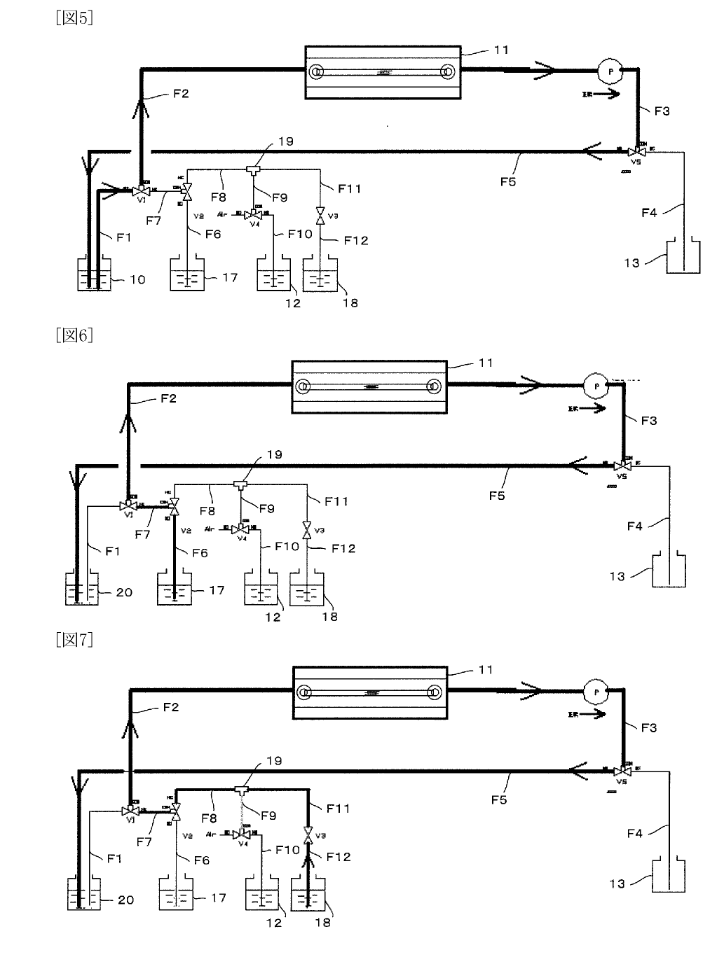

FIG. 6 is a schematic view of a flow path system for explaining a staining step of staining the microorganisms captured by using the apparatus for concentrating dielectric micro particles 1 in accordance with the embodiment of the present invention.

In the staining step of staining the microorganisms, the stain liquid supplied from the stain liquid holding portion 17 is flowed through the dielectrophoretic electrodes within the cell 11, and the stain liquid flowing out of the cell 11 is returned to the waste liquid holding portion 20. At this time, the sine-wave voltage is applied to the dielectrophoretic electrodes, so as to prevent the captured microorganisms from being peeled off together with the stain liquid and flowing out. In this case, the waste liquid holding portion 20 may be used together with the liquid sample holding unit 10.

The flow path system opens the flow path F₆-F₇ by the electromagnetic valve V₂, and opens the flow path F₇-F₂ by the electromagnetic valve V₁, in order to secure the flow path F₆ flowing the stain liquid out of the stain liquid holding portion 17 and the flow path F₂ for flowing the stain liquid through the cell 11. Further, the flow path F₃-F₅ for flowing the stain liquid (the stain waste liquid) out of the cell 11 so as to flow into the waste liquid holding portion 20 is formed by the electromagnetic valve V₅. Accordingly, the flow path F₆-F₇-F₂-F₃-F₅ is formed. In other words, in the staining step of staining the microorganisms, the flow path is formed in such a manner as to secure the flow path system among the stain liquid holding portion 17, the cell 11 and the waste liquid holding portion 20, disconnect the flow path system with the collection unit 13 so as to prevent the stain liquid itself from being collected by the collection unit 13, and disconnect the flow path system with the release liquid holding unit 12 and the washing liquid holding portion 18. Further, the structure is made such as to prevent the stain waste liquid from the cell 11 from flowing into the stain liquid holding portion 17, by forming an open loop flow path among the stain liquid holding portion 17, the cell 11 and the waste liquid holding portion 20.

### Pre-Release Washing Step

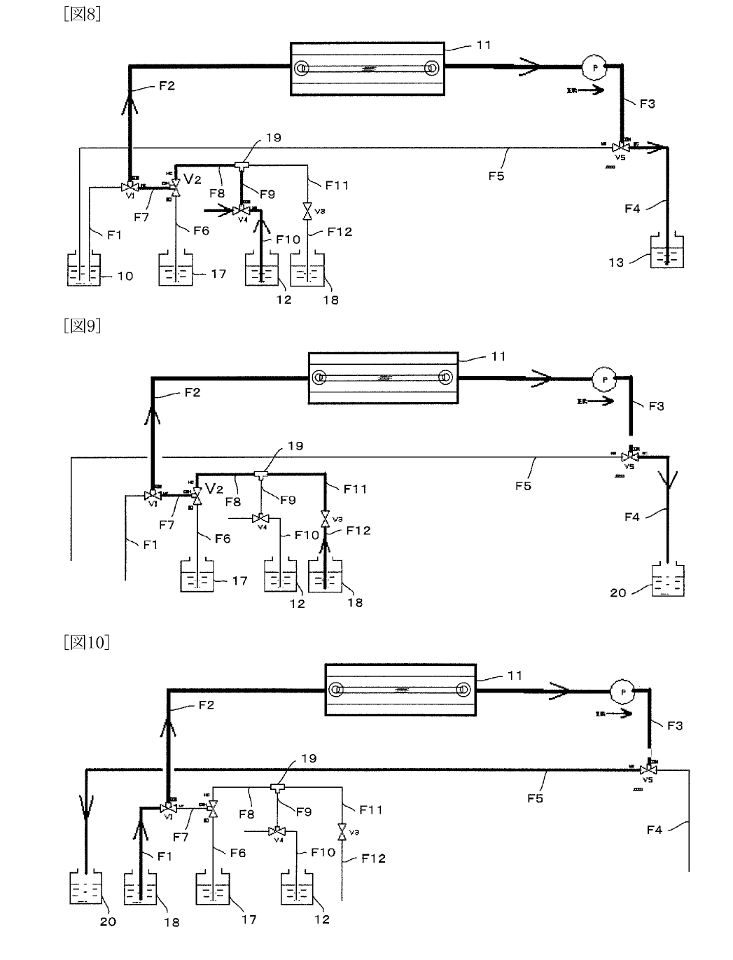

FIG. 7 is a schematic view of a flow path system for explaining a pre-release washing step before releasing the microorganisms captured by using the apparatus for concentrating dielectric micro particles 1 in accordance with the embodiment of the present invention.

The pre-release washing step aims at washing the flow paths F₇, F₂ and F₃ particularly having a high possibility of mixing the stain liquid into the release liquid in the flow paths which are in common to both the staining step and the releasing step, the cell 11 connected thereto and the liquid feed pump P, in such a manner as to prevent the stain liquid remaining by the staining step from being mixed with the release liquid and being collected by the collection unit 13, in the flow path F₆-F₇-F₂-F₃-F₅ through which the stain liquid flows by the staining step, and the flow path F₁₀-F₉-F₈-F₇-F₂-F₃-F₄ collecting the microorganisms by the release step, before collecting the microorganisms captured by the dielectrophoretic electrodes of the cell 11.

In the pre-release washing step, the washing liquid supplied from the washing liquid holding portion 18 is flowed through the dielectrophoretic electrodes within the cell 11, and the washing liquid (the washing waste liquid) flowing out of the cell 11 is returned to the waste liquid holding portion 20. At this time, the sine-wave voltage is applied to the dielectrophoretic electrodes, and prevents the captured microorganisms from being peeled off together with the washing liquid so as to be flowed out. In this case, the waste liquid holding portion 20 may be used together with the liquid sample holding unit 10.

The flow path system opens the flow path F₁₂-F₁₁ by the electromagnetic valve V₃, opens the flow path F₈-F₇ by the electromagnetic valve V₂, and opens the flow path F₇-F₂ by the electromagnetic valve V₁, in order to secure a flow path F₁₂ flowing the washing liquid out of the washing liquid holding portion 18 and the flow path F₂ for flowing the washing liquid through the cell 11. Further, flow path F₃-F₅ for flowing the washing waste liquid out of the cell 11 so as to flow into the waste liquid holding portion 20 is formed by the electromagnetic valve V₅. In this case, flow path F₁₁-F₈ is always formed by the T-shaped joint 19. Accordingly, a flow path F₁₂-F₁₁-F₈-F₇-F₂-F₃-F₅ is formed. In other words, in the pre-release washing step, the flow path is formed in such a manner as to secure the flow path system among the washing liquid holding portion 18, the cell 11 and the waste liquid holding portion 20, disconnect the flow path system with the collection unit 13 in such a manner as to prevent the washing liquid itself from being collected by the collection unit 13, and disconnect the flow path system with the stain liquid holding portion 17 and the release liquid holding unit 12. Further, the structure is made such as to prevent the washing waste liquid from being flowed into the washing liquid holding portion 18, by forming an open loop flow path among the washing liquid holding portion 18, the cell 11 and the waste liquid holding portion 20.

In this case, the washing liquid remains in the flow path F₉ by using the T-shaped joint 19, and there is a possibility that the washing liquid and the release liquid are mixed at a time of the releasing step. In the case that this is not allowed, the T-shaped joint is replaced with a three-way valve. In this case, since it is necessary to form the flow path F₉-F₈ and the flow path F₁₁-F₈, the flow path F₈ is connected to the common port.

### Releasing Step

FIG. 8 is a schematic view of a flow path system for explaining a releasing step of releasing the microorganisms captured by using the apparatus for concentrating dielectric micro particles 1 in accordance with the embodiment of the present invention.

In the releasing step, the release liquid supplied from the release liquid holding unit 12 is flowed through the dielectrophoretic electrodes within the cell 11, and the microorganisms captured by the dielectrophoretic electrodes are peeled off so as to be collected as the concentrated liquid together with the release liquid to the collection unit 13. At this time, the voltage application to the dielectrophoretic electrodes is stopped, whereby the captured microorganisms are peeled off together with the release liquid so as to flow out. It is possible to more easily peel off the microorganisms captured by the dielectrophoretic electrodes by intermittently mixing the air bubbles, at a time of supplying the release liquid. In this case, since it is only possible to alternatively select the formation of the flow path F₁₀-F₉ or the formation of the flow path between the open side for mixing the air bubbles and the flow path F₉, due to the function of the electromagnetic valve V₄, the release liquid or the air bubbles is alternatively supplied, so that the intermittent operation is required.

Further, it is possible to concentrate the microorganisms so as to collect, by making an amount of the release liquid supplied in the releasing step smaller than that of the liquid sample.

The flow path system opens the flow path F₁₀-F₉ by the electromagnetic valve V₄, opens the flow path F₈-F₇ by the electromagnetic valve V₂, and opens the flow path F₇-F₂ by the electromagnetic valve V₁, in order to secure the flow path F₁₀ flowing the release liquid out of the release liquid holding unit 12 and the flow path F₂ for flowing the release liquid to the cell 11. Further, the flow path F₃-F₄ for flowing the microorganisms including the release liquid out of the cell 11 so as to flow into the collection unit 13 is formed by the electromagnetic valve V₅. In this case, the flow path F₉-F₈ is always formed by the T-shaped joint 19. Accordingly, the flow path F₁₀-F₉-F₈-F₇-F₂-F₃-F₄ is formed. In other words, in the release step, the flow path is formed in such a manner as to secure the flow path system among the release liquid holding unit 12, the cell 11 and the collection unit 13. Further, the microorganisms are concentrated so as to be collected, by forming the open loop flow path among the release liquid holding unit 12, the cell 11 and the collection unit 13.

### Washing Step

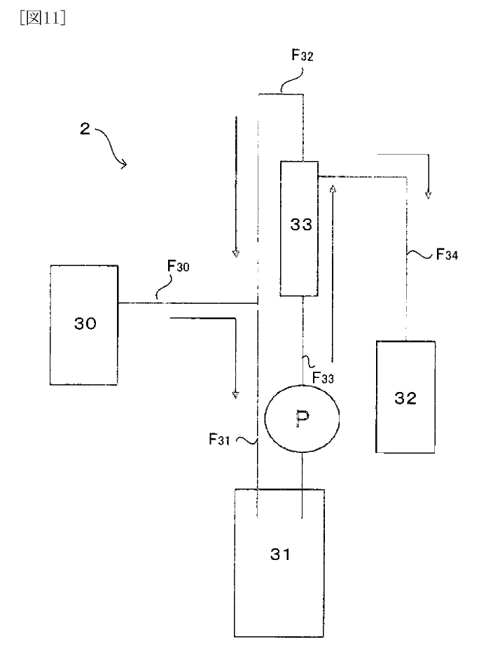

FIGS. 9 and 10 are schematic views of a flow path system for explaining a washing step of washing the flow path system of the apparatus for concentrating dielectric micro particles 1 in accordance with the embodiment of the present invention.

In FIG. 9, a flow path system among the washing liquid holding portion 18, the cell 11 and the waste liquid holding portion 20 is secured by replacing the collection unit 13 with the waste liquid holding portion 20 after collecting the concentrated liquid. In other words, since the flow path F₁₂-F₁₁-F₈-F₇-F₂-F₃-F₄ is formed by opening the flow path F₁₂-F₁₁ by the electromagnetic valve V₃, opening the flow path F₈-F₇ by the electromagnetic valve V₂, opening the flow path F₇-F₃ by the electromagnetic valve V₁, and opening the flow path F₃-F₄ by the electromagnetic valve V₅, it is possible to wash the flow paths mentioned above.

In FIG. 10, in order to wash the flow path F₅, the washing liquid holding portion 18 is connected to the flow path F₁, and the waste liquid holding portion 20 is connected to the flow path F₅. In other words, since the flow path F₁-F₂-F₃-F₅ is formed by opening the flow path F₁-F₂ by the electromagnetic valve V₁, and opening the flow path F₃-F₅ by the electromagnetic valve V₅, it is possible to wash the flow path mentioned above.

### Cross Flow

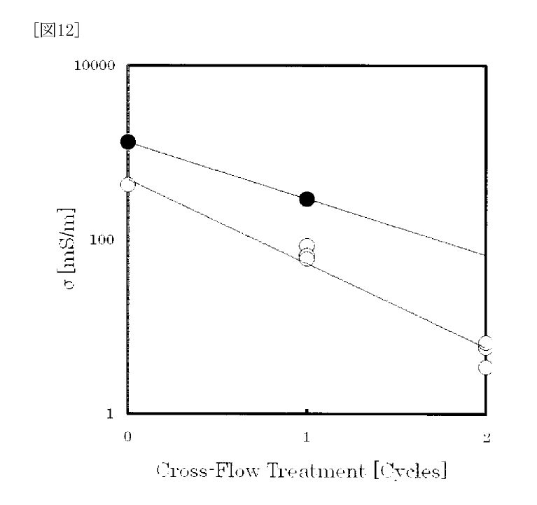

FIG. 11 is a schematic view of a flow path system of a cross flow apparatus 2 corresponding to a pre-treatment mechanism of the apparatus for concentrating dielectric micro particles 1 in accordance with the embodiment of the present invention.

The cross flow apparatus 2 is mainly constructed by an introduction portion 30, a concentration sample portion 31, a filtration liquid collection unit 32, and a cross flow portion 33. In addition, a flow path system can be provided with the liquid feed pump P, and a valve.

The liquid sample or the washing liquid before the cross flow holds the introduction portion 30, and any of the liquids is introduced into the cross flow apparatus 2. The liquid sample is introduced in a preparing step and a concentrating step, and the washing liquid is introduced in the washing step. The introduction portion 30 is connected by a flow path F30.

The concentration sample portion 31 is structured such as to collect the liquid including the dielectric micro particles (the microorganisms) separated by the cross flow portion 33, and is connected by an inflow path F₃₁ and an outflow path F₃₃. In the case of combinedly using the apparatus for concentrating dielectric micro particles 1 and the cross flow apparatus 2, it is possible to construct the concentration sample portion 31 so as to be identical with or be coupled to the liquid sample holding unit 10.

The filtration liquid collection unit 32 is structured such as to collect the liquid including the electrolyte material separated by the cross flow portion 33, and is connected by an inflow path F₃₄.

The cross flow portion 33 has a hollow fiber membrane which can transmit the electrolyte material and is hard to transmit the dielectric micro particles (the microorganisms), for separating the electrolyte material, and is connected by the inflow path F₃₃ and the outflow paths F₃₂ and F₃₄.

A description will be given of a step of separating the electrolyte material by using the cross flow apparatus 2 having the structure mentioned above. First of all, the liquid sample before the cross flow is filled in the flow path formed as mentioned above from the introduction portion 30, by forming the flow path F₃₀-F₃₁-F₃₃-F₃₂, in other words, by communicating the introduction portion 30, the concentration sample portion 31 and the cross flow portion 33 (a preparing step).

Next, the electrolyte material is separated by the cross flow portion 33 by forming the flow paths F₃₀-F₃₁-F₃₃-F₃₂ and F₃₄, in other words, by communicating the introduction portion 30, the concentration sample portion 31, the filtration liquid collection unit 32 and the cross flow portion 33 (a concentrating step). Specifically, the electrolyte material corresponding to a smaller component than a hole diameter of the hollow fiber membrane is transmitted by the pressure from the liquid feed pump P so as to be collected in the filtration liquid collection unit 32. On the other hand, the dielectric micro particles (the microorganisms) corresponding to a larger component than the hole diameter of the hollow fiber membrane remains on the hollow fiber membrane without being transmitted. Further, the liquid sample before the cross flow in an amount corresponding to an amount of the fluid collected as the filtration liquid in the filtration liquid collection unit 32 is introduced from the introduction portion 30. This concentrating step is carried on until the liquid sample of the introduction portion 30 runs short.

If the liquid sample of the introduction portion 30 runs short, the washing liquid is introduced by changing the introduction portion 30 to a washing liquid (a pure water) while keeping the flow paths F₃₀-F₃₁-F₃₃-F₃₂ and F₃₄ to be formed (the washing step). The dielectric micro particles (the microorganisms) remaining on the hollow fiber membrane or in the flow path are flowed into the concentration sample portion 31.

Finally, the flow paths F₃₀ and F₃₄ are disconnected, and the concentration sample remaining in the flow path is washed out by a small amount of washing liquid which is independently introduced so as to be flowed into the concentration sample portion 31 by the flow path F₃₃-F₃₂-F₃₁ (a collecting step).

As mentioned above, the liquid sample in which the electric conductivity is lowered is reserved in the concentration sample portion 31. In this case, an amount of concentration can be decided by the liquid sample before the cross flow filled in the concentration sample portion 31 in the preparing step and the amount of the washing liquid used for washing.

FIG. 12 is a view showing a reduction of an electric conductivity of a medium by the cross flow. As a result of an experiment carried out by using an artificial sea water, the electric conductivity of the medium is lowered in accordance that the number of the cross flow is increased.

### INDUSTRIAL APPLICABILITY

Since the apparatus for concentrating dielectric micro particles in accordance with an aspect of the present invention can collect the target fungus as the concentrated liquid obtained by concentrating the microorganisms, from a large amount of liquid sample including the microorganisms, it is useful as the structure which can concentrate the target fungus in a short time, when a capturing technique having a high rapidity and a high efficiency is demanded.

Further, it is possible to provide the microorganisms stained by applying the stain liquid before concentrating and collecting the microorganisms as the target fungus to the measuring apparatus. This can usefully prevent a precision of measurement from being deteriorated on the basis of the attachment of the stain liquid to each part of the apparatus, in the measuring apparatus which is independently provided. Deterioration of each part of the apparatus can also be prevented accordingly.

What is claimed is:

1. An apparatus for concentrating dielectric micro particles comprising:
a liquid sample holding unit holding a liquid sample including the dielectric micro particles coming to a subject to be inspected;
a cell provided with dielectrophoretic electrodes capturing said dielectric micro particles on the basis of dielectrophoretic force;
a release liquid holding unit holding a release liquid flowing through said dielectrophoretic electrodes; and
a collection unit flowing the release liquid supplied from said release liquid holding unit through said dielectrophoretic electrodes and collecting the dielectric micro particles captured by said dielectrophoretic electrodes.

2. An apparatus for concentrating dielectric micro particles as claimed in claim 1, wherein the apparatus further comprises a stain liquid holding portion holding a stain liquid for applying a labeling material with respect to the dielectric micro particles captured by said dielectrophoretic electrodes.

3. An apparatus for concentrating dielectric micro particles as claimed in claim 1, wherein air bubbles are mixed into the release liquid, at a time of flowing the release liquid supplied from said release liquid holding unit through said dielectrophoretic electrodes.

4. An apparatus for concentrating dielectric micro particles as claimed in claim 1, wherein said dielectrophoretic electrodes are covered by a coating film for preventing adsorption of a protein.

5. An apparatus for concentrating dielectric micro particles as claimed in claim 1, wherein an electrolyte material affecting an electric conductivity has been previously separated from said liquid sample.
